(19) United States
(12) Patent Application Publication
(10) Pub. No.: US 2009/0028541 A1
(43) Pub. Date: Jan. 29, 2009

(54) Movable flash adapter

(76) Inventor: Alexandr V. Livitz, Melrose, MA (US)

Correspondence Address: Joanne M. Martin, 40 North Spring Street, Concord, NH, 03301-3902, US

(21) Appl. No.: 11/901,430

(22) Filed: Sep. 17, 2007

Related U.S. Application Data
(60) Provisional application No. 60/845,459, filed on Sep. 18, 2006.

(51) Int. Cl. G03B 15/04

(52) U.S. Cl. 396/422

(57) ABSTRACT

An adapter connected to a camera providing a rapidly movable support of a camera flash between flash positions favorable to a portrait and a landscape camera orientation, including a annular track, such as provided on a portion of an annular band mounted forward of the camera body, typically concentric with the lens axis. The arcuate portion provides a track on which a flash holder rides and is retained, wherein the flash holder includes opposing rolling members to engage parallel members of the arcuate portion therebetween and roll thereon as the flash holder moves from one location to another. By substantially surrounding the lens instead of the camera body, the present invention provides a flexible compact flash adapter which further protects the camera lens.

### FIELD OF THE INVENTION

The present invention relates to devices which facilitate mounting camera accessories to the camera body, in particular, to flash supports connected to the camera body which permit movement of the flash about the optical axis of the camera lens.

### BACKGROUND OF THE INVENTION

In professional photography, the camera and some closely associated equipment are often integrated into a camera body that has significant weight (e.g. 4.5 Kg) and for that reason, have provided contoured bodies or integrated grips for easy control and reduced user fatigue. Typically, the camera will have an integrated grip for one or both the landscape and portrait camera orientation, which grip(s) are valued and used by the photographer, especially as control of the camera in either of the positions may need to change very quickly, and such repositioning may occur constantly over possibly many hours of shooting. Moreover, cameras, especially sophisticated professional cameras, have many controls distributed over many of the surfaces of the camera body, especially within easy finger movement of the grips, and unblocked access is also vitally important. It is also important to the professional photographer who handles the camera for lengthy times and in different places that require the camera to frequently be unpacked and packed, that the total camera (with associated equipment) weight and bulk be kept to a minimum.

When the photographer shoots where appropriate fixed lighting, e.g. in a studio, is not possible, a camera-mounted flash is used. If the camera provides a flash fitting, e.g. a ‘shoe’, in which to receive the flash, the flash favors only one orientation (either landscape or portrait), leaving the other orientation with shadows cast in an undesirable direction. Alternately, if a second shoe is provided for the alternate orientation, there is simply not enough time to reposition the flash between shoes, and the equipment will have accelerate wear from this constant attaching and removal. The use of brackets as currently available, between the camera body and flash unit, to provide a flash support movable relative to the camera body (and typically centered about the camera body), typically increases the distance between the point of the light in the flash and the optical axis of the camera lens, making shadows more pronounced or otherwise undesirable. Moreover, the attention of the photographer is drawn away from scene composition and the operation of the camera towards the outboard position of the flash and it connection to holders and brackets, etc. which are placed away from the camera body or lens, and the outboard placement of the flash significantly changes the ‘balance’ of the camera as held by the photographer, making it seem bulky, unwieldy (making the camera more vulnerable to damage) and more intrusive. Also, typical flash brackets interfere, obscure or block access to important camera controls and block easy access to the grips integrated into the camera housing, and prevent the use of existing camera bags, containers, etc. without disassembling the flash, bracket and camera, which takes more time and causes more wear on the equipment.

Therefore, the photographer is very sensitive to the connection, positioning and operation of a camera flash, and the present flash brackets are do not provide the structure or function necessary for a professional photographer, especially in a lengthy shooting session.

### SUMMARY OF THE PRESENT INVENTION

The movable flash adapter according to the present invention provides a support comprising an arcuate track and a slider to which the flash is connected, for quickly and controllably moving the flash over an angle (relative to the lens optical axis) in a plane centered not about the camera body, but forward of it and about the lens itself, with a significantly smaller radius than previously available. The arcuate track is supported forward of the camera body with a bracket with a portion that connects to the camera body (such as at the conventional mounting screw locations which are often centered near one of the camera grips) and extends away from the connection to the camera body, and further includes an forwardly extending portion disposed to provide easy access to the grips and camera body controls.

The particular embodiments may also include an annular support having the arcuate portion as a part thereof, and the forwardly extending bracket further provides connection to the annular support at two positions thereabout, and may further comprise embodiments that provide connections to the arcuate track at two positions, e.g. one connection at either track end. The annular support is dimensioned to provide easy access to camera and lens settings and to permit interchange of lenses on the camera body.

The particularly embodiments may further include roller supports to provide easy movement along the arcuate track while remaining captive thereon in other directions, further with detents along the arcuate track, such as at two positions space to provide a 90° angle relative to the optical axis of the lens, into which the rollers find and resiliently stop as the slider is moved, until urged out by the application of a side force in either direction along the arcuate track.

### BRIEF DESCRIPTION OF THE DRAWING

These and further features of the present invention will be better understood by reading the following Detailed Description together with the Drawing, wherein

FIG. 1 is a perspective view of one embodiment of the present invention shown in a portrait orientation and connected to a typical camera;

FIG. 2 is a perspective view of the embodiment if FIG. 1 of the present invention shown in a landscape orientation and connected to a typical camera; and

FIG. 3 is a partial cut-away perspective view of the embodiment of FIG. 1, showing a roller slide implementation.

### DETAILED DESCRIPTION OF AN EXEMPLARY EMBODIMENT

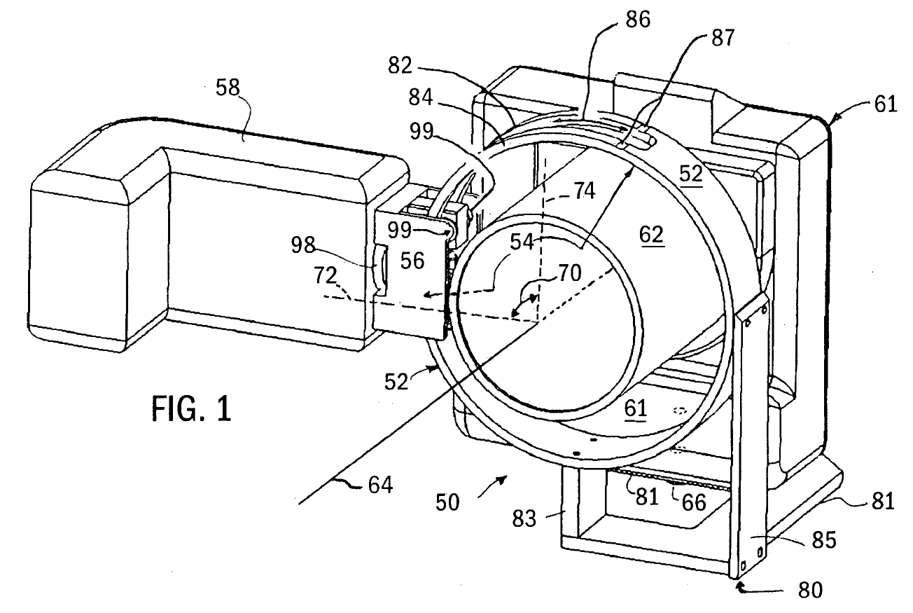

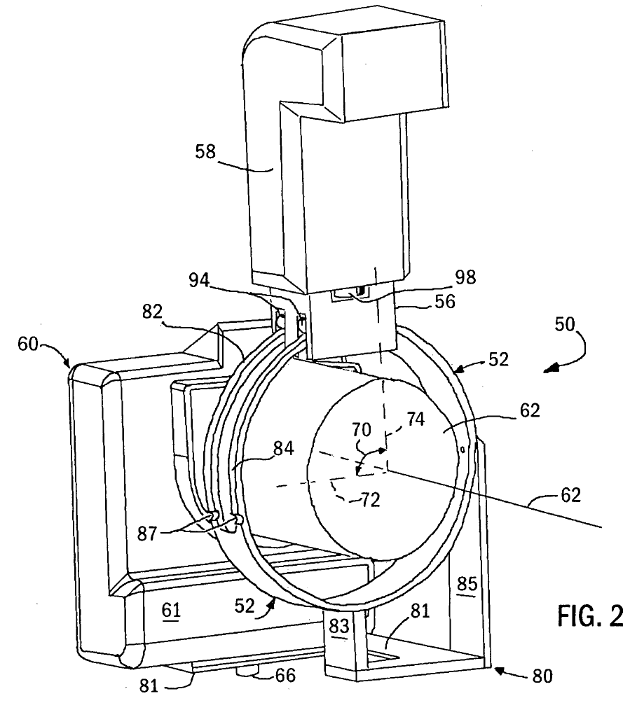

The exemplary embodiment 50, shown in the portrait orientation in FIG. 1 and in the landscape orientation in FIG. 2, shows an annular support 52 having an arcuate portion 54, which provides a support to a slider 56 which retains the flash 58 and moves on the arcuate portion through an angle 70 defined by rays 72 and 74, drawn to the slider portrait and landscape (of FIG. 2) positions, respectively, relative to the optical axis 64 of the lens 62, wherein the angle 70 is typically 90°, but may be a lesser angle, or a larger angle, such as up to approximately 270° for the embodiment of FIGS. 1-3. The arcuate portion 54 comprises two curved parallel portions 82, 84 of annular support 52 forming a track, and formed by removing a portion 84 along the radial length of the annular support in the region of desired travel of the slide 56 and typically slightly more than the range of desired travel. As the parallel portions 82, 84 receive the slider 56, further details of the parallel portions are made to be compatible with the slider 56, or alternate embodiments as may be provided. The parallel portions (or optionally a single portion) may also include a detent 87 or other narrowing or marking of the portion to provide a marking or indentation to cause the slider 56 to favor or stop at such position along the portion(s).

The annular support 52 is typically connected to a camera 60 body with a member 80 having a portion 81 through which a captive bolt 66 mates to the standard camera threaded mount, or by any other suitable device. The member 80 connects to the annular support 52 with two sections 83, 85 and attach at two separate places on the support 52. Alternate embodiments provide connection to and support of the arcuate portion 54 preferably from both ends thereof, or alternately from one position therealong. The portion 81 extends a length to accommodate the distance to the camera 60 support point, often near the grip 61, and is formed to continue at an angle therefrom towards the sections 83, 85 which retain the annular support 54, thus providing unobstructed access to the grip 61 and any surrounding or nearby user controls (not shown) located near or on the camera 60 body. In the exemplary embodiment shown, the portion 81 includes an L-shaped section connected to said camera 60 by a screw 66 slidably retained therein. Moreover, the portion 81 includes a threaded or slide tripod mount (not shown) or appropriate connector to a tripod mount therealong.

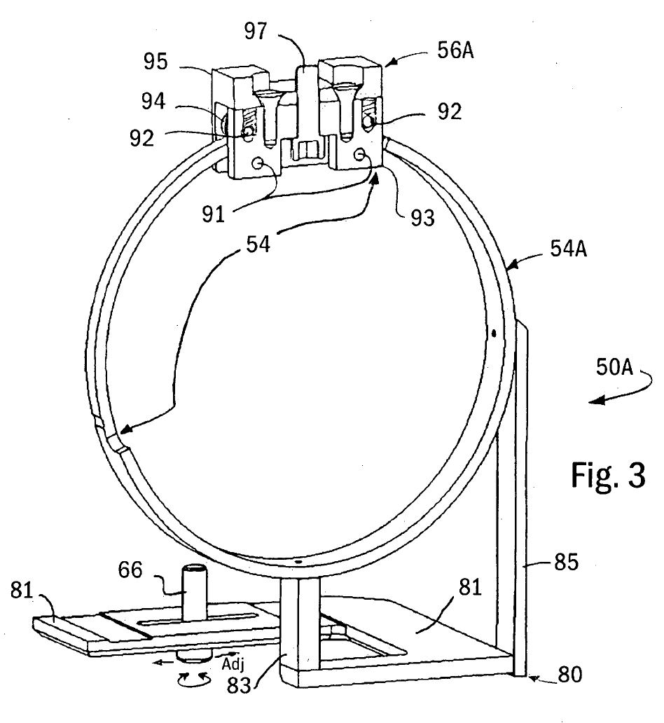

In the cut-away of the embodiment 50A, a half section 56A providing an interior view of the slider 56 is shown in FIG. 3, wherein the annular support (54) is bisected 54A along its radial length, showing a single curved portion 82. The slider half-section 56A includes rollers (e.g. 99, FIG. 1) disposed on the radius side of the of the annular support on shafts 91 supported by slider inner support 93 and further comprise rollers 94 disposed on the exterior of the annular support 56 and retained by shafts 92 resiliently or spring loaded relative to a slider exterior support 95. The inner support 93 and the exterior support 95 are held together by screws 96. A flash 58 retaining screw 97 is received through the supports 93, 95 and receives a externally accessible nut (98, FIG. 3) which engages the screw 97 via an aperture in the slider 56 to secure the flash 58 to the slider 56. If equipped with detents 87, at least one roller will engage the detent 87 as the slider is moved along the portions 82, 84. Alternate embodiments of either the slider 56 (and the constituent elements) and the mating portion(s) 82, 84 may be provided by one of ordinary skill, to provide the desired positioning at least for the portrait and landscape orientations of the flash proximal to the lens 62 about the optical axis 64.

Further modifications and substitutions are within the scope of the present invention, which is not limited except by the claims which follow.

What is claimed is:

1. For use with a camera having a lens extending forward therefrom, a flash holder, comprising:
a flash bracket comprising an arcuate portion circumscribing a center and having a track thereon, said track having a first and a second end;
a flash receiver retained on said flash bracket and configured to mate with said track; and
a camera mount including a member adapted to connect to said camera and extend forward from said camera to connect to said flash bracket track first and second end, wherein said track is disposed forward of said camera and said center substantially coincides with said lens.

2. The flash holder of claim 1, wherein said flash bracket comprises an annular member generally disposed in a plane, said arcuate portion being included therein, and said plane being displaced from said camera.

3. The flash holder of claim 2, wherein said lens has an optical axis, and said annular member has a center of radius substantially coincident with said optical axis of said lens.

4. The flash holder of claim 1, wherein said camera mount includes an L-shaped section connected to said camera.

5. The flash holder of claim 1, wherein said camera mount includes a plurality of connections to said track.

6. The flash holder of claim 1, wherein said track is at least a 90 degree angle about an optical axis of said lens.

7. The flash holder of claim 1, wherein said track further includes a detent thereon, and said flash receiver includes a support element selectively movable over said track and into said detent.

8. A flash mount for a camera having a body and a lens extending thereon with a viewing axis, comprising:
an arcuate member having a curvature in a plane substantially concentric to a radius point, said arcuate member being connected to said connection fixture to at least partially surround said lens and wherein said plane is perpendicular to said lens viewing axis;
a flash receiver retained on said arcuate member and movable therealong; and
support member having a camera connector at a first location and an arcuate member connector distal from said camera connector and connected to said arcuate member to provide said camera connector displaced from said arcuate member plane;

9. The flash mount of claim 8, wherein said flash receiver is movable from a first to a second position therealong providing an angle relative therebetween relative to said viewing axis, said angle being substantially 90° and greater.

10. The flash mount of claim 9, wherein said flash receiver includes rollers disposed on opposite sides of said arcuate member.

11. The flash mount of claim 10, wherein said arcuate member includes indentations at selected positions therealong, and said rollers at least partially mate with said indentations to present a resistance to movement away from said indentations.

12. The flash mount of claim 8, wherein said arcuate member comprises an annular member.

13. A method of operating a camera having a grip thereon, a lens extending away from said camera, and an associated flash in a portrait and a landscape mode, comprising the steps of:
providing an arcuate track about said lens;
mounting said arcuate track forward of said camera and clear of said grip; and
providing a slider movable on said track over an angle about said camera lens, wherein said slider receives a flash thereon.

14. The method of claim 13, wherein said step of providing an arcuate track comprises the step of providing an annular member, said arcuate track being a portion thereof.
